(19) United States
(12) Patent Application Publication
(10) Pub. No.: US 2025/0298300 A1
(43) Pub. Date: Sep. 25, 2025

(54) BEAM PROJECTION APPARATUS AND PROJECTOR THEREOF

(71) Applicant: QISDA CORPORATION, Taoyuan City (TW)

(72) Inventors: Chih-Shiung Chien, Taoyuan City (TW); Ming-Kuen Lin, Taoyuan City (TW)

(73) Assignee: QISDA CORPORATION, Taoyuan City (TW)

(21) Appl. No.: 19/011,654

(22) Filed: Jan. 7, 2025

(30) Foreign Application Priority Data
Mar. 22, 2024 (CN) 202410336608.5

(51) Int. Cl. G03B 21/20; G03B 21/16

(52) U.S. Cl. CPC G03B 21/204; G03B 21/16; G03B 21/2053; G03B 21/2066

(57) ABSTRACT

A beam projection apparatus includes a light source, micromirror component, a light guide lens set, a projection lens, a condensing lens with a lens portion and an asymmetrical lens portion extending from the lens portion and having a cut surface, and a wavelength conversion component disposed at a side of the condensing lens for at least partially converting a wavelength of a color light and reflecting the color light to the condensing lens. The light source is disposed corresponding to the cut surface and emits the color light. The micromirror component is disposed at another side of the condensing lens relative to the wavelength conversion component. The light guide lens set is disposed on a light exit axis of the lens portion to guide the color light to be incident to the micromirror component for forming a projection beam. The projection lens receives the projection beam for optical projection.

### BACKGROUND OF THE INVENTION

### 1. FIELD OF THE INVENTION

The present invention relates to a beam projection apparatus and a projector thereof, and more specifically, to a beam projection apparatus forming a cut surface on a condensing lens and disposing a light source at a position corresponding to the cut surface and a projector thereof.

### 2. DESCRIPTION OF THE PRIOR ART

In general, as shown in FIG. 1, a beam projection apparatus 1 applied to a projector or vehicle illumination usually utilizes a blue laser source to provide a color light. The color light must pass through a condensing lens 2 and a wavelength conversion component 3 (e.g., a color wheel partially coated with a phosphor layer) to be converted into another excited color light, and then the another excited color light and the original color light pass through a light guide lens set 4, a digital micromirror device (DMD) 5, and a projection lens 6 to produce a multicolor laser beam required for subsequent image projection.

In the aforesaid configuration, since stray reflections of the color light occur when the color light is incident into internal optical components of the beam projection apparatus, unexpected and unnecessary light leakage paths P (as shown in FIG. 1) often appear inside the beam projection apparatus to cause a light leakage problem, so as to significantly affect the image projection or lighting quality of the beam projection apparatus. In the prior art, the above light leakage problem could be solved by blocking the leakage paths P (e.g., placing a light blocking sheet at a bottom position in front of the projection lens 6 as shown in FIG. 1). However, this light blocking design also causes a reduction in the overall brightness of the beam projection apparatus.

### SUMMARY OF THE INVENTION

The present invention provides a beam projection apparatus including at least one condensing lens, at least one light source, a wavelength conversion component, a micromirror component, light guide lens set, and at least one projection lens. The at least one condensing lens has a lens portion and an asymmetrical lens portion, and the asymmetrical lens portion extends from the lens portion and has a cut surface. The at least one light source is disposed corresponding to the cut surface and emits a color light. The wavelength conversion component is disposed at a side of the at least one condensing lens for at least partially converting a wavelength of the color light and reflecting the color light to the at least one condensing lens for making the color light travel along a light exit axis of the lens portion. The micromirror component is disposed on another side of the condensing lens relative to the wavelength conversion component. The light guide lens set is disposed on the light exit axis to guide the color light to be incident to the micromirror component for forming a projection beam. The at least one projection lens is disposed on the light exit axis to receive the projection beam for optical projection.

The present invention further provides a projector including at least one condensing lens, at least one light source, a wavelength conversion component, a micromirror component, a light guide lens set, and at least one projection lens. The at least one condensing lens has a lens portion and an asymmetrical lens portion, and the asymmetrical lens portion extends from the lens portion and has a cut surface. The at least one light source is disposed corresponding to the cut surface and emits a color light. The wavelength conversion component is disposed at a side of the at least one condensing lens for at least partially converting a wavelength of the color light and reflecting the color light to the at least one condensing lens for making the color light travel along a light exit axis of the lens portion. The micromirror component is disposed at another side of the condensing lens relative to the wavelength conversion component. The light guide lens set is disposed on the light exit axis to guide the color light to be incident to the micromirror component for forming a projection beam. The at least one projection lens receives the projection beam for optical projection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view of a beam projection apparatus according to the prior art.

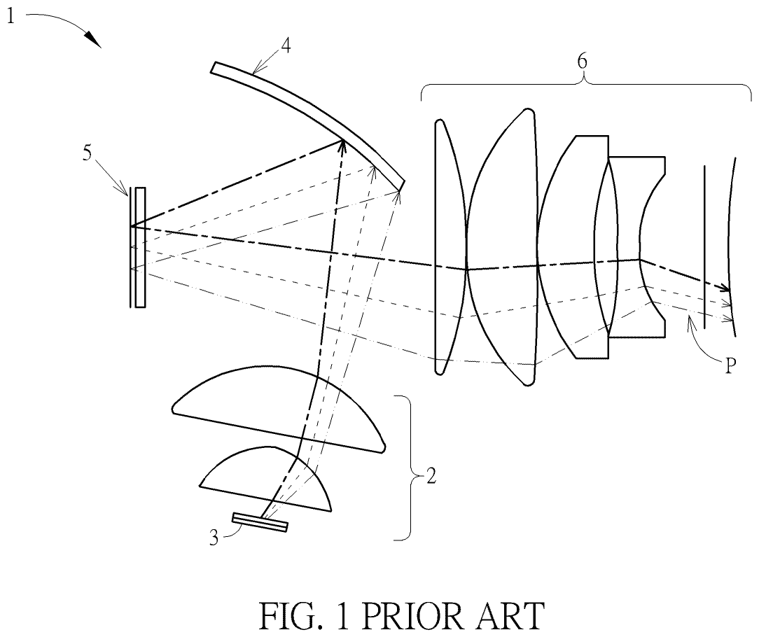

FIG. 2 is a side view of a beam projection apparatus according to an embodiment of the present invention.

FIG. 3 is a top view of a condensing lens in FIG. 2.

FIG. 4 is a side view of a beam projection apparatus according to another embodiment of the present invention.

FIG. 5 is a side view of a beam projection apparatus according to another embodiment of the present invention.

FIG. 6 is a side view of a beam projection apparatus according to another embodiment of the present invention.

FIG. 7 is an enlarged diagram of a color wheel of a wavelength conversion component in FIG. 6.

### DETAILED DESCRIPTION

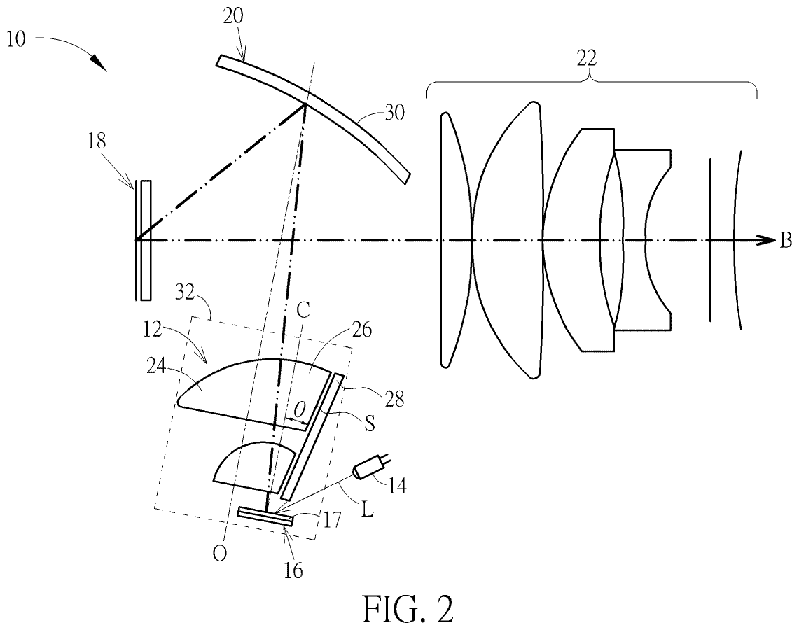

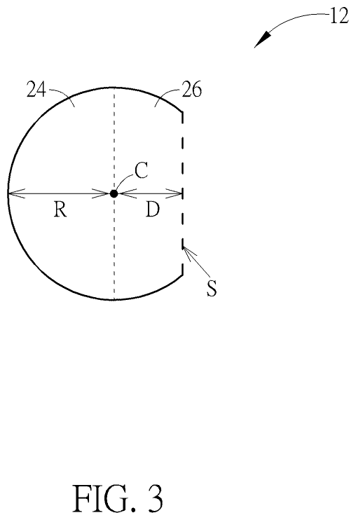

Please refer to FIGS. 2 and 3. FIG. 2 is a side view of a beam projection apparatus 10 according to an embodiment of the present invention, and FIG. 3 is a top view of a condensing lens 12 in FIG. 2. The beam projection apparatus 10 could be preferably applied to vehicle lighting for projecting illumination beams as headlights or to projection imaging for providing projection beams as a projector (but not limited thereto). As shown in FIG. 2, the beam projection apparatus 10 includes at least one condensing lens 12 (two shown in FIG. 2, but not limited thereto), at least one light source 14 (one shown in FIG. 2, but not limited thereto), a wavelength conversion component 16, a micromirror component 18, a light guide lens set 20, and at least one projection lens 22 (six shown in FIG. 2, but not limited thereto).

The condensing lens 12 could be preferably a collimator lens (but not limited thereto) and includes a lens portion 24 and an asymmetrical lens portion 26. The asymmetrical lens portion 26 extends from the lens portion 24 and has a cut surface S to collimate a color light emitted by the light source 14. As shown in FIGS. 2 and 3, in this embodiment, a distance D between the cut surface S and a central axis C of the lens portion 24 could be preferably less than or equal to three-quarters of a radius R of the lens portion 24, and an angle 0 between the cut surface S and the central axis C of the lens portion 24 could be preferably between 0° and 60°, but not limited thereto, meaning that a forming position of the cut surface S and the angle of the cut surface S relative to the central axis C of the lens portion 24 could vary depending on actual light leakage paths of the beam projection apparatus 10. In addition, the beam projection apparatus 10 could further include a light blocking sheet 28. The light blocking sheet 28 is opposite to the cut surface S to block light emitted by the light source 14 from entering the cut surface S, thereby preventing additional light scattering and leakage caused by the cut surface S in the beam projection apparatus 10.

The light source 14 is disposed corresponding to the cut surface S and emits a color light L directly to the wavelength conversion component 16 without passing through the asymmetrical lens portion 26. The wavelength conversion component 16 is disposed on a side of the condensing lens 12 to at least partially convert a wavelength of the color light L and reflect the color light L back to the condensing lens 12, allowing the color light L to travel along a light exit axis O of the lens portion 24. To be more specific, in this embodiment, the wavelength conversion component 16 could include at least one fluorescent layer 17 (one shown in FIG. 2, but not limited thereto), so that the color light L can be incident on the fluorescent layer 17 and be excited to produce a wavelength conversion phenomenon. For example, the light source 14 could preferably be a laser or LED light source emitting a blue light, and the fluorescent layer 17 could be a yellow phosphor layer. Accordingly, the fluorescent layer 17 can convert the color light L into a yellow light, and then the yellow light can be mixed with the reflected color light L to form a white light. Alternatively, the fluorescent layer 17 could be a red-green phosphor layer, which can convert the color light L into a red light and a green light, and then the red light and the green light can be mixed with the reflected color light L to form a white light. However, the types of color light and phosphor layers can vary according to actual optical projection requirements of the beam projection apparatus 10. To be noted, in this embodiment, the wavelength conversion component 16 could be movable on the side of the condensing lens 12 to enhance the color light excitation effect and prevent overheating of the wavelength conversion component 16. For example, as shown in FIG. 2, the wavelength conversion component 16 could move reciprocally relative to the condensing lens 12 (e.g., moving left and right along a direction perpendicular to the central axis C in FIG. 2, but not limited thereto). In another embodiment, the wavelength conversion component 16 could be a phosphor wheel to rotate relative to the condensing lens 12.

Furthermore, as shown in FIG. 2, the micromirror component 18 is disposed on another side of the condensing lens 12 relative to the wavelength conversion component 16. The light guide lens set 20 is disposed on the light exit axis 0 to guide the color light L to the micromirror component 18 for forming a projection beam B, and then the projection lens 22 can receive the projection beam B for optical projection. To be more specific, in this embodiment, the micromirror component 18 could be preferably a digital micromirror device, the light source 14 and the micromirror component 18 are disposed on two sides of the light exit axis 0, and the light guide lens set 20 could include a reflective concave mirror 30 disposed on the light exit axis 0. As such, the reflective concave mirror 30 can reflect the wavelength-converted light traveling along the light exit axis O of the lens portion 24 to the micromirror component 18, and then the micromirror component 18 reflects the received light to form the projection beam B, so as to make the projection beam B pass through the projection lens 22, thereby allowing the beam projection apparatus 10 to provide a multicolor laser beam necessary for subsequent optical projection.

In summary, compared with the prior art directly utilizing a light blocking sheet to block light leakage paths, the present invention adopts the aforesaid cut surface design to remove an area on the condensing lens where light leakage paths occur. In such a manner, the present invention can effectively solved the light leakage problem caused by the stray light reflections mentioned in the prior art, so as to significantly improve the image projection or lighting quality of the beam projection apparatus. Furthermore, the present invention adopts the aforesaid design in which the light source is disposed corresponding to the cut surface for improving the utilization efficiency of internal space of the beam projection apparatus to be advantageous to the thinning design of the beam projection apparatus.

In practical applications, the beam projection apparatus 10 could include a diffuser, a light homogenizing component (preferably a lens array, but not limited thereto), or a light adjusting component (e.g., a reflective mirror or a convex/concave lens) disposed between the light source 14 and the wavelength conversion component 16. Accordingly, the diffuser could further diffuse and homogenize the energy and directionality of the color light L. The light homogenizing component could receive the color light L from the light source 14 to perform color light mixing, thereby producing light splitting, beam shaping, and light spot merging effects. The light adjusting component could be used to focus or diverge the color light L, change the beam size of the color light, or alter the traveling direction of the color light L. As for which configuration (or any combination) is adopted, it depends on the actual optical projection requirements of the beam projection apparatus 10. In addition, the beam projection apparatus 10 could include a heat dissipation substrate 32 (simply represented by a dashed box in FIG. 2), which can simultaneously hold the condensing lens 12 and the wavelength conversion component 16. The aforesaid design not only improves the internal heat dissipation efficiency of the beam projection apparatus 10, but also achieves modular heat dissipation, thereby further reducing space occupied by internal components of the beam projection apparatus 10 to be advantageous to the thinning design of the beam projection apparatus 10.

Furthermore, the beam projection apparatus 10 could include another light source disposed on another side of the wavelength conversion component 16 relative to the condensing lens 12, for emitting another color light (e.g., a blue light, but not limited thereto) to the wavelength conversion component 16. As such, the aforesaid color light be could at least partially wavelength-converted, so as to further improve the projection brightness of the beam projection apparatus 10.

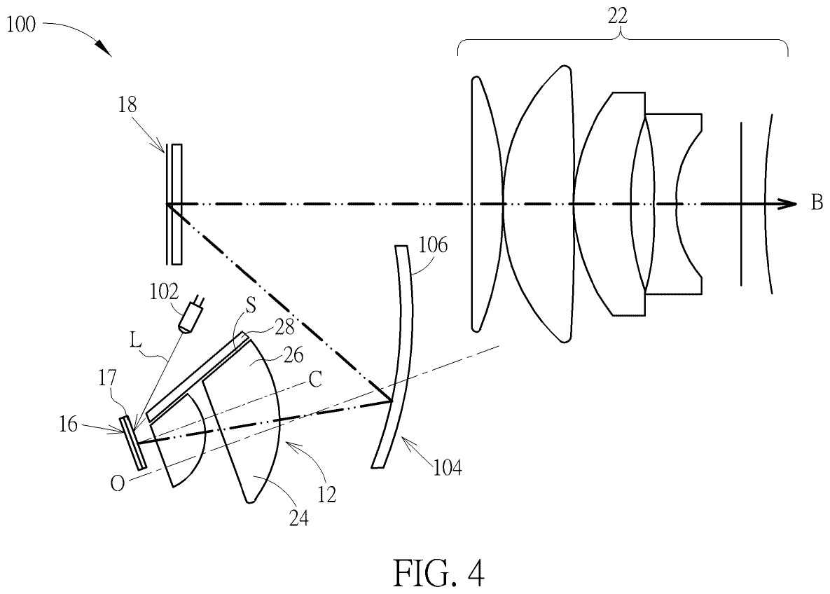

It should be mentioned that, in addition to the aforementioned design of disposing the light source and the micromirror component on opposite sides of the light exit axis of the condensing lens, the present invention could also adopt a design in which the light source and the micromirror component are disposed on the same side of the light exit axis. For example, please refer to FIG. 4, which is a side view of a beam projection apparatus 100 according to another embodiment of the present invention. Components both mentioned in this embodiment and the aforesaid embodiments represent components with similar structures or functions, and the related description is omitted herein. As shown in FIG. 4, the beam projection apparatus 100 includes the condensing lens 12, at least one light source 102 (one shown in FIG. 4, but not limited thereto), the wavelength conversion component 16, the micromirror component 18, a light guide lens set 104, and the projection lens 22. In this embodiment, the light guide lens set 104 includes a reflective concave mirror 106, the light source 102 and the micromirror component 18 are located on the same side of the light exit axis 0, and the reflective concave mirror 106 is disposed on the light exit axis 0. Accordingly, the color light L emitted by the light source 102 can be directly incident to the wavelength conversion component 16 without passing through the asymmetrical lens portion 26 for at least partial wavelength conversion, and then be reflected by the wavelength conversion component 16 to the condensing lens 12. Subsequently, the color light L travels along the light exit axis 0 of the lens portion 24 and is reflected by the reflective concave mirror 106 to the micromirror component 18 for forming the projection beam B. At the same time, the projection lens 22 receives the projection beam B for optical projection. As for the other related description for the beam projection apparatus 100 (e.g., the aforesaid designs of the diffuser, the light homogenizing component, the light adjusting component, the heat dissipation substrate and another light source), it could be reasoned by analogy according to the aforesaid embodiments and omitted herein.

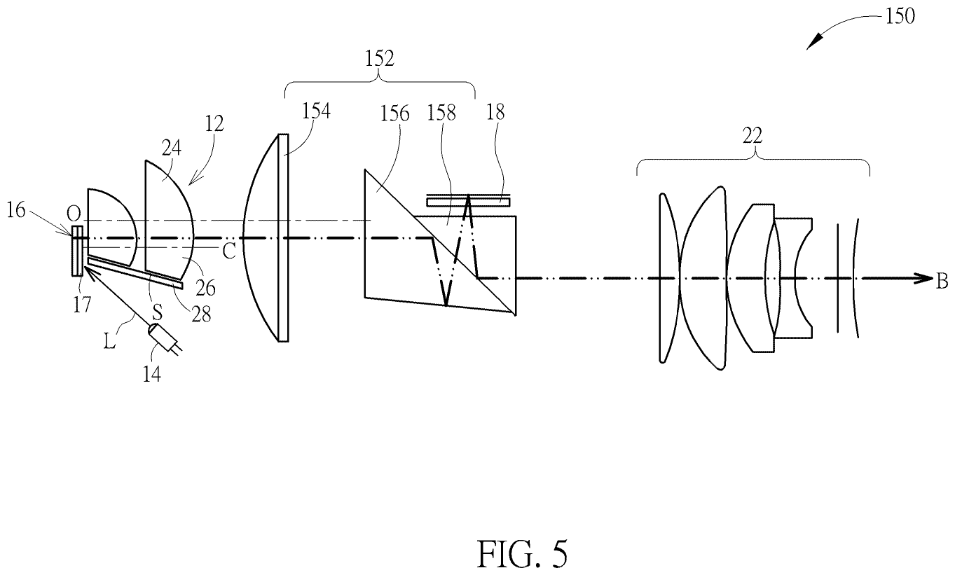

Furthermore, the present invention could also adopt a dual-prism configuration. For example, please refer to FIG. 5, which is a side view of a beam projection apparatus 150 according to another embodiment of the present invention. Components both mentioned in this embodiment and the aforesaid embodiments represent components with similar structures or functions, and the related description is omitted herein. As shown in FIG. 5, the beam projection apparatus 150 includes the condensing lens 12, the light source 14, the wavelength conversion component 16, the micromirror component 18, a light guide lens set 152, and the projection lens 22. In this embodiment, the light guide lens set 152 includes at least one illumination lens 154 (one shown in FIG. 5, but not limited thereto), a first triangular prism 156, and a second triangular prism 158. The illumination lens 154 is disposed on the light exit axis 0 between the condensing lens 12 and the first triangular prism 156. The first triangular prism 156 is disposed on the light exit axis O to reflect the color light L from the illumination lens 154 to the second triangular prism 158. The second triangular prism 158 is opposite to the first triangular prism 156 on the light exit axis 0 and allows the color light L reflected by the first triangular prism 156 to pass therethrough to be incident to the micromirror component 18, and the projection beam B returned by the micromirror component 18 is then reflected to the projection lens 22 by the second triangular prism 158. As such, the projection lens 22 can receive the projection beam B from the light guide lens set 152 for optical projection. As for the other related description for the beam projection apparatus 150 (e.g., the aforesaid designs of the diffuser, the light homogenizing component, the light adjusting component, the heat dissipation substrate and another light source), it could be reasoned by analogy according to the aforesaid embodiments and omitted herein.

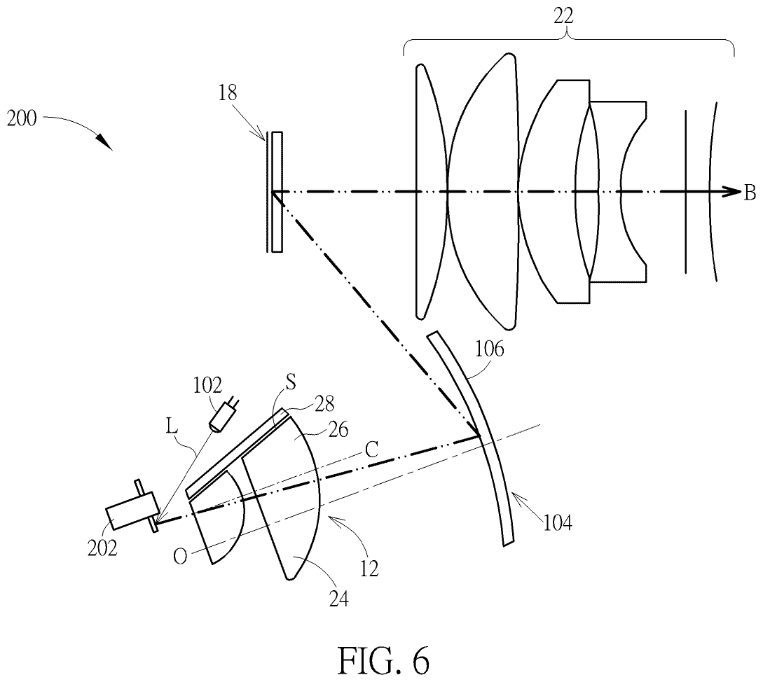

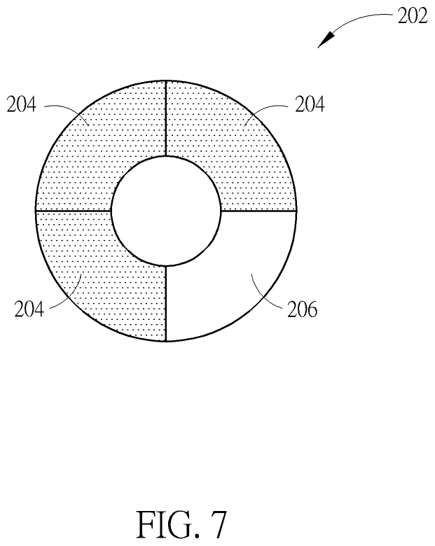

Moreover, in addition to the single fluorescent layer design, the present invention could adopt a rotatable fluorescent color wheel design. For example, please refer to FIGS. 6 and 7. FIG. 6 is a side view of a beam projection apparatus 200 according to another embodiment of the present invention. FIG. 7 is an enlarged diagram of a color wheel of a wavelength conversion component 202 in FIG. 6. Components both mentioned in this embodiment and the aforesaid embodiments represent components with similar structures or functions, and the related description is omitted herein. As shown in FIGS. 6 and 7, the beam projection apparatus 200 includes the condensing lens 12, the light source 102, a wavelength conversion component 202, the micromirror component 18, the light guide lens set 104, and the projection lens 22. In this embodiment, the wavelength conversion component 202 is a rotatable fluorescent color wheel and includes at least one fluorescent layer 204 (preferably red/green/green fluorescent layers shown in FIG. 7, but not limited thereto) and is rotatably disposed on one side of the condensing lens 12. Furthermore, the wavelength conversion component 202 could also include a reflective layer 206, and the color light L can be incident on the reflective layer 206 and then reflected to the condensing lens 12. During the rotation of the fluorescent color wheel, the color light L emitted by the light source 102 is incident to the fluorescent layer 204 to be converted into a red light and a green light, and the color light L is reflected to the condensing lens 12 by the reflective layer 206 without wavelength conversion. As such, the red light and the green light excited by the fluorescent layer 204 can be mixed with the reflected color light to form a white light for subsequent optical projection. As for the other related description for the beam projection apparatus 200 (e.g., the aforesaid designs of the diffuser, the light homogenizing component, the light adjusting component, the heat dissipation substrate and another light source), it could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A beam projection apparatus comprising:
at least one condensing lens having a lens portion and an asymmetrical lens portion, the asymmetrical lens portion extending from the lens portion and having a cut surface;
at least one light source disposed corresponding to the cut surface and emitting a color light;
a wavelength conversion component disposed at a side of the at least one condensing lens for at least partially converting a wavelength of the color light and reflecting the color light to the at least one condensing lens for making the color light travel along a light exit axis of the lens portion;
a micromirror component disposed on another side of the condensing lens relative to the wavelength conversion component;
a light guide lens set disposed on the light exit axis to guide the color light to be incident to the micromirror component for forming a projection beam; and
at least one projection lens disposed on the light exit axis to receive the projection beam for optical projection.

2. The beam projection apparatus of claim 1, wherein a distance between the cut surface and a central axis of the lens portion is less than or equal to three-quarters of a radius of the lens portion.

3. The beam projection apparatus of claim 1, wherein an angle between the cut surface and a central axis of the lens portion is between 0° and 60°.

4. The beam projection apparatus of claim 1, wherein the at least one light source and the micromirror component are disposed on two sides of the light exit axis, and the light guide lens set comprises a reflective concave mirror disposed on the light exit axis to guide the color light to the micromirror component.

5. The beam projection apparatus of claim 1, wherein the light source and the micromirror component are disposed on the same side of the light exit axis, and the light guide lens set comprises a reflective concave mirror disposed on the light exit axis to guide the color light to the micromirror component.

6. The beam projection apparatus of claim 1, wherein the light guide lens set comprises at least one illumination lens, a first triangular prism, and a second triangular prism, the at least one illumination lens is disposed on the light exit axis and located between the at least one condensing lens and the first triangular prism, the first triangular prism is disposed on the light exit axis to reflect the color light from the at least one illumination lens to the second triangular prism, and the second triangular prism is opposite to the first triangular prism and disposed on the light exit axis for allowing the color light reflected by the first triangular prism to pass therethrough to be incident to the micromirror component and reflecting the projection beam returned by the micromirror component to the at least one projection lens.

7. The beam projection apparatus of claim 1, wherein the beam projection apparatus further comprises a light blocking sheet opposite to the cut surface for blocking the color light from entering the at least one condensing lens through the cut surface.

8. The beam projection apparatus of claim 1, wherein the beam projection apparatus further comprises a diffuser disposed between the wavelength conversion component and the at least one light source.

9. The beam projection apparatus of claim 1, wherein the beam projection apparatus further comprises a light homogenizing component disposed between the wavelength conversion component and the at least one light source.

10. The beam projection apparatus of claim 9, wherein the light homogenizing component is a lens array.

11. The beam projection apparatus of claim 1, wherein the beam projection apparatus further comprises a light adjusting component disposed between the wavelength conversion component and the at least one light source for focusing the color light, diverging the color light, changing a beam size of the color light, or altering a traveling direction of the color light.

12. The beam projection apparatus of claim 1, wherein the beam projection apparatus further comprises a heat dissipation substrate holding the at least one condensing lens and the wavelength conversion component.

13. The beam projection apparatus of claim 1, wherein the wavelength conversion component comprises at least one fluorescent layer, and the color light is incident on the at least one fluorescent layer for wavelength conversion.

14. The beam projection apparatus of claim 13, wherein the wavelength conversion component is a fluorescent color wheel, and the fluorescent color wheel comprises the at least one fluorescent layer and is rotatably disposed on the side of the at least one condensing lens.

15. The beam projection apparatus of claim 14, wherein the fluorescent color wheel further comprises a reflective layer, and the color light is incident on the reflective layer to be reflected to the at least one condensing lens.

16. The beam projection apparatus of claim 13, wherein the at least one condensing lens is a collimator lens, the at least one light source is a laser source or an LED light source, the at least one fluorescent layer is a yellow phosphor layer, the color light is a blue light, the at least one fluorescent layer converts the color light into a yellow light, and the yellow light is mixed with the color light to form a white light.

17. The beam projection apparatus of claim 13, wherein the at least one condensing lens is a collimator lens, the at least one light source is a laser source or an LED light source, and the at least one fluorescent layer is a red-green phosphor layer, the color light is a blue light, the at least one fluorescent layer converts the color light into a red light and a green light, and the red light and the green light are mixed with the color light to form a white light.

18. The beam projection apparatus of claim 1, wherein the beam projection apparatus further comprises another light source disposed on another side of the wavelength conversion component relative to the at least one condensing lens, for emitting another color light to the wavelength conversion component for at least partially converting a wavelength of the another color light.

19. A projector comprising:
at least one condensing lens having a lens portion and an asymmetrical lens portion, the asymmetrical lens portion extending from the lens portion and having a cut surface;
at least one light source disposed corresponding to the cut surface and emitting a color light;
a wavelength conversion component disposed at a side of the at least one condensing lens for at least partially converting a wavelength of the color light and reflecting the color light to the at least one condensing lens for making the color light travel along a light exit axis of the lens portion;
a micromirror component disposed at another side of the condensing lens relative to the wavelength conversion component;
a light guide lens set disposed on the light exit axis to guide the color light to be incident to the micromirror component for forming a projection beam; and
at least one projection lens receiving the projection beam for optical projection.
